(19) United States
(12) Patent Application Publication
(10) Pub. No.: US 2007/0285731 A1
(43) Pub. Date: Dec. 13, 2007

(54) Image sensor device, image reading apparatus, and image forming apparatus

(75) Inventor: Naohiro Yasuda, Kanagawa (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 11/802,333

(22) Filed: May 22, 2007

(30) Foreign Application Priority Data
May 23, 2006 (JP) 2006-143131
Apr. 3, 2007 (JP) 2007-097443

(51) Int. Cl. H04N 1/00

(52) U.S. Cl. 358/401

(57) ABSTRACT

An image sensor device converts reflected light from an image surface of an original into an electric signal, and includes a substrate, a light transmitting unit, and a light receiving unit. The light transmitting unit is located on the substrate, and transmits the reflected light. The light receiving unit receives the reflected light. The light transmitting unit and the light receiving unit are arranged so that the reflected light passes through the light transmitting unit and is incident to the light receiving unit.

### CROSS-REFERENCE TO RELATED APPLICATIONS

The present document incorporates by reference the entire contents of Japanese priority document, 2006-143131 filed in Japan on May 23, 2006 and 2007-097443 filed in Japan on Apr. 3, 2007.

### BACKGROUND OF THE INVENTION

1. Field of the Invention

The present invention relates to an image sensor device, an image reading apparatus, and an image forming apparatus.

2. Description of the Related Art

An image reader provided in an image forming apparatus, such as a digital copier, and a signal image reading apparatus include an image sensor device using an image sensor element. A charge-coupled device (CCD) is used for the image sensor element, in many cases. However, when this CCD is operated at high speed, the CCD generates heat, which may not only increase dark noise but also render it impossible to maintain reliability of the CCD. Particularly, when a light receiving unit of the image sensor element has a small area to decrease cost, the package size also becomes small. Therefore, heat dissipation becomes an important technical issue in increasing the speed.

To improve heat dissipation, it is desirable to fit a heat dissipation member to a part other than a heat reception part of the image sensor element, particularly, the back surface of the image sensor element. However, this back surface is usually closely adhered to a circuit board mounted, and has no space in which the heat dissipation member is fitted. There is a method of securing a fitting space, and inserting the heat dissipation member into between the back surface of the image sensor element and the circuit board. However, in this case, a lead terminal of the image sensor element to be connected to the circuit board needs to be set long. When the lead terminal is set long, there is a problem that the lead terminal receives noise from other circuit, and the lead terminal gives noise to other circuit on the other hand. Therefore, it is difficult to set the lead terminal long to be able to sufficiently secure volume or the surface area of the heat dissipation member.

To cope with the problem, there has been proposed a conventional technology in which a heat dissipation member is fitted to another part than the back surface of the image sensor element to improve heat dissipation. For example, Japanese Patent No. 3005112 discloses a configuration in which an elastic member having high thermal conductance or a sheet spring member having high thermal conductance is arranged in contact with a CCD and a lens block which fixes the CCD.

However, according to the conventional technology, the heat dissipation member is arranged on a cover glass of the CCD where light is incident, which restricts the contact area of the heat dissipation member. Thus, sufficient heat dissipation effect cannot be achieved.

### SUMMARY OF THE INVENTION

It is an object of the present invention to at least partially solve the problems in the conventional technology.

According to an aspect of the present invention, an image sensor device that converts reflected light from an image surface into an electric signal, includes a substrate, a light transmitting unit that is located on the substrate and transmits the reflected light, and a light receiving unit that receives the reflected light. The light transmitting unit and the light receiving unit are arranged so that the reflected light passes through the light transmitting unit and is incident to the light receiving unit.

According to another aspect of the present invention, an image reading apparatus includes an image sensor device that converts reflected light from an image surface into an electric signal, and that includes a substrate, a light transmitting unit that is located on the substrate and transmits the reflected light, and a light receiving unit that receives the reflected light. The light transmitting unit and the light receiving unit are arranged so that the reflected light passes through the light transmitting unit and is incident to the light receiving unit.

According to still another aspect of the present invention, an image forming apparatus comprising an image reading apparatus including an image sensor device that converts reflected light from an image surface into an electric signal. The image sensor device includes a substrate, a light transmitting unit that is located on the substrate and transmits the reflected light, and a light receiving unit that receives the reflected light. The light transmitting unit and the light receiving unit are arranged so that the reflected light passes through the light transmitting unit and is incident to the light receiving unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an image reading apparatus according to a first embodiment of the present invention;

FIGS. 2A to 2C are schematic diagrams of an image sensor device shown in FIG. 1;

FIGS. 3A and 3B are schematic diagrams of a conventional image sensor device;

FIG. 4 is a modification of the image reading apparatus;

FIGS. 5A and 5B are schematic diagrams of an image sensor device according to a second embodiment of the present invention;

FIG. 6 is a side view of an image sensor device according to a third embodiment of the present invention; and

FIG. 7 is a side view of an image sensor device according to a fourth embodiment of the present invention.

### DETAILED DESCRIPTION OF THE PREFERRED EMBODIMENTS

Exemplary embodiments of the present invention are explained in detail below with reference to the accompanying drawings.

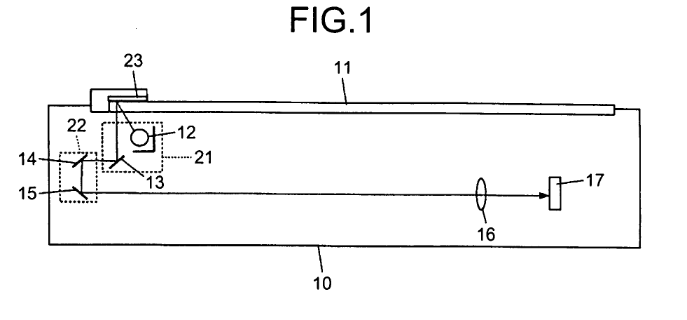

FIG. 1 is a schematic diagram of an image reading apparatus according to a first embodiment of the present invention. In the following embodiments, the image reading apparatus is applied to a single scanner of an image forming apparatus such as a digital copier including a scanner and a printer, or as a single scanning apparatus. The image reading apparatus reads a plane image from an original by moving a reading line at a constant speed using an image sensor arrayed in one dimension. However, the present invention is not restricted to the embodiments, and can be similarly applied to an apparatus that reads an image using a CCD (or an image sensor similar to the CCD, such as a complimentary metal-oxide semiconductor (CMOS) sensor) arrayed two-dimensionally, such as a digital still camera or a video camera.

The image reading apparatus includes a frame 10, a contact glass (document table) 11 on which a document is set, a light source (exposure lamp) 12, a first mirror 13, a second mirror 14, a third mirror 15, a lens 16, an image sensor device 17, a first scanning unit 21, a second scanning unit 22, and a shading plate (white reference plate) 23.

The light source 12, the first mirror 13, the second mirror 14, the third mirror 15, the lens 16, and the image sensor device 17 constitute an optical scanning system.

The image sensor device 17 includes a CCD 30 as an image sensor element, and a substrate (printed wiring board (PWB)) for mounting the CCD 30. The configuration of the image sensor device 17 is explained in detail later.

The light source 12 and the first mirror 13 are fixed to the upper part of the first scanning unit 21, and the second mirror 14 and the third mirror 15 are fixed to the upper part of the second scanning unit 22. In reading an image surface of the document, the first scanning unit 21 and the second scanning unit 22 are moved parallel to the document. In this case, the first scanning unit 21 and the second scanning unit 22 are mechanically moved (scanned) at relative speeds of two to one so that a distance between the image surface of the document to be read on the contact glass 11 and the CCD 30 of the image sensor device 17, that is, an optical length, is constant. A scanner motor (not shown) drives the first scanning unit 21 and the second scanning unit 22. Constituent elements of the first scanning unit 21 and the second scanning unit 22 are not particularly limited to the above.

The CCD 30 of the image sensor device 17 reads the image of the document set on the contact glass 11, converts the read image into an electric analog signal, and processes the analog signal. In other words, the light source 12 of the optical scanning system illuminates the image surface of the document, and forms a reflected optical image from the image surface onto the light receiving surface of the CCD 30 of the image sensor device 17 via the first mirror 13, the second mirror 14, the third mirror 15, and the lens 16. The CCD 30 converts the shading or colors of the image on the document into an electric analog signal.

The shading plate 23 is used to fetch shading correction data.

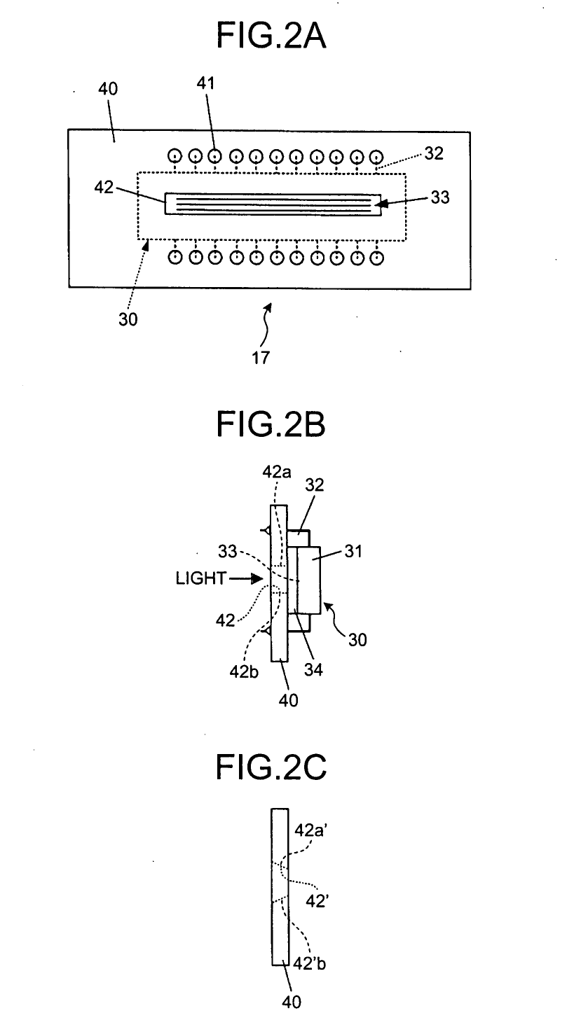

FIG. 2A is a top plan view of the image sensor device 17. FIGS. 2B and 2C are side views of the image sensor device 17. The image sensor device 17 includes the CCD 30 as the image sensor element, and a substrate 40 on which the CCD 30 is mounted.

The CCD 30 converts the shading or colors of the image on the document into an electric analog signal. The CCD 30 includes a package body 31, lead terminals 32, a light receiving unit (image sensor) 33, and a glass portion 34.

The package body 31 protects the inside of the CCD 30. A plurality of lead terminals protrudes from both side surfaces of the package body 31 in a width direction of the package body (direction perpendicular to the line direction). These lead terminals 32 have approximately an L shape having the lead terminals 32 bent to the light receiving unit 33, that is, to the light incident surface, in the middle. These lead terminals 32 are electrically and mechanically connected to the substrate 40. The light receiving unit 33 is disposed on the package body 31, and receives a reflected optical image from the image surface of the document. In the first embodiment, the CCD 30 is assumed to have three light receiving units 33 into which colors are divided by three filters of different colors: R (red), G (green), and B (blue). The glass portion 34 is arranged on the package body 31 to have light incident to the three light receiving units 33.

The substrate 40 is configured to receive an analog signal from the CCD 30 and transmit the received analog signal to an image forming unit (not shown). The substrate 40 includes input and output (I/O) terminals 41, a light transmitting unit 42, and a circuit (not shown). The I/O terminals 41 are through-holes (wiring holes having conductivity) that are provided by the same number as that of the lead terminals 32 at the same intervals as those of the lead terminals 32, in a diameter larger than that of the lead terminals 32 of the CCD 30.

The light transmitting unit 42 is an opening having a rectangular cross-section provided at a part surrounded by the I/O terminals 41. This opening is formed as a hollow part of the substrate 40. A positional relationship between the I/O terminals 41 and the light transmitting unit 42 is the same as the positional relationship between the lead terminals 32 of the CCD 30 and the light receiving units 33. When the lead terminals 32 are introduced into the I/O terminals 41, the center of the light transmitting units 42 and the center of the light receiving units 33 are approximately at the same positions. The opening area of the light transmitting unit 42 is larger than the area in which the light receiving units 33 of the CCD 30 are formed. A circuit is provided in each layer (the substrate 40 is a four-layer substrate in the first embodiment), and the circuit transmits an analog signal received from the CCD 30 to the image forming unit.

The CCD 30 and the substrate 40 are electrically and mechanically connected to each other by piercing the lead terminals 32 of the CCD 30 through the I/O terminals 41 of the substrate 40, and then soldering the lead terminals 32 to the I/O terminals 41. The lead terminals 32 are bent to the light receiving units 33 as described above, and the CCD 30 and the substrate 40 are provided so that the glass portion 34 and the substrate 40 face each other based on the soldering of the lead terminals 32 and the I/O terminals 41. The area in which the light receiving units 33 are formed is accommodated within the range of the area of the opening of the light transmitting unit 42. As a result, the light receiving units 33 are exposed from the substrate 40 based on the arrangement of the light transmitting unit 42. Based on the configuration of the image sensor device 17, light focused by the lens 16 disposed at the opposite side of the mounting of the CCD 30 on the substrate 40 passes through the light transmitting unit 42 of the substrate 40 and is incident to the light receiving units 33 of the CCD 30.

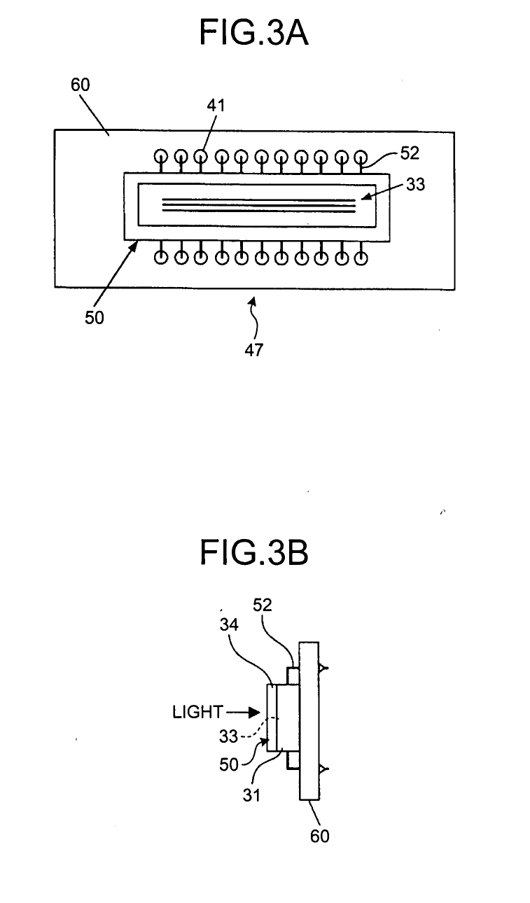

The reason why the image sensor device 17 is configured as above is explained below. FIG. 3A is a top plan view of a conventional image sensor device 47. FIG. 3B is a side view of the image sensor device 47. Like reference numerals refer to like portions as those of the image sensor device 17 shown in FIGS. 2A to 2C.

The image sensor device 47 includes a CCD 50, and a substrate 60 on which the CCD 50 is mounted. The CCD 50 includes the package body 31, a lead terminal 52, the light receiving units 33, and the glass portion 34. The substrate 60 also includes the I/O terminals 41, and a circuit (not shown).

The lead terminal 52 is stretched from the package body 31, and is bent to the substrate 60 which is at the opposite side of the light receiving units 33. Therefore, the CCD 50 and the substrate 60 are soldered (mounted) together so that the back surface of the CCD 50 (the surface on which the package body 31 is exposed) face the substrate 60. Based on this configuration of the image sensor device 47, light focused by the lens 16 disposed at the same side as the mounting surface of the CCD 50 on the substrate 60 is directly incident to the light receiving unit 33.

To increase heat dissipation of the CCD 50, it is preferable to provide a heat dissipation member. As shown in FIGS. 3A to 3B, the heat dissipation member can be usually fitted to a part other than the surface (the glass portion 34) where light is incident. It is easiest to use the side surface of the CCD 50. However, because the area of the side surface is small, sufficient heat dissipation effect cannot be obtained. The largest surface (the surface on which the package body 31 is exposed) is in contact with the substrate 60. To fit the heat dissipation member using this surface, the heat dissipation member needs to be disposed between the substrate 60 and the CCD 50.

However, insertion of a heat dissipation member between the substrate 60 and the CCD 50 increases a distance between the substrate 60 and the CCD 50. Therefore, the length of the lead terminals 52 of the CCD 50 reaching the through-holes of the I/O terminals 41 of the substrate 60 becomes a constraint to the thickness of the heat dissipation member. Consequently, it becomes difficult to sufficiently secure a volume or a surface area of the heat dissipation member to improve heat dissipation efficiency. Even when a shape of the heat dissipation member is attempted to be increased, a constraint occurs in the shape of the heat dissipation member, because the lead terminals 52 are present on both sides of the CCD 50 in the width direction of the CCD. When the length of the lead terminals 52 is increased to sufficiently secure the volume or the surface area of the heat dissipation member, a problem occurs that the lead terminals 52 receive noise from other circuits or the lead terminals 52 give noise to other circuits.

On the other hand, in the image sensor device 17 according to the first embodiment, the lead terminals 32 of the CCD 30 are bent to the light receiving unit 33 at the light incident surface side, in a direction opposite to that of the lead terminals of the conventional image sensor device, and the glass portion 34 of the CCD 30 is mounted in a positional relationship of facing the substrate 40. The light transmitting unit 42 is formed on the substrate. After the CCD 30 and the substrate 40 are mounted, the three light receiving units 33 of the CCD 30 are accommodated within the range of the light transmitting unit 42. In other words, the light receiving units 33 are exposed from the substrate 40. In this configuration, the whole surface of the CCD 30 opposite to the light incident surface (the surface on which the package body 31 is exposed) becomes an open state. Therefore, the heat dissipation efficiency of the CCD 30 is improved substantially. Accordingly, the CCD 30 can be driven at high speed, without fitting a heat dissipation member or a cooling member to the back surface of the CCD 30 (the back surface on which the package body 31 is exposed).

As shown in FIG. 2B, in the light transmitting unit 42, a wall-surface upper part 42a and a wall-surface lower part 42b in the thickness direction of the substrate 40 (light incident direction), and a wall-surface left part and a wall-surface right part (not shown) are mutually in parallel. However, these units are not limited to be arranged in this shape. For example, as shown in FIG. 2C, a light transmitting unit 42′ can be configured so that the inner circumference surface of a substrate hollow part that becomes the light transmitting unit 42′ (i.e., each inner-wall surface of a wall-surface upper part 42a′, a wall-surface lower part 42b′, and the wall-surface left part and the wall-surface right part not shown) is tapered from a surface of the substrate 40 in which the light is incident toward a surface of the substrate 40 from which light focused by the lens 16 is output.

When this light transmitting unit 42 is used, even when the light that is focused by the lens 16 and passes through the light transmitting unit 42′ is reflected by the inner circumference surface of the light transmitting unit 42′ (i.e., each inner-wall surface of the wall-surface upper part 42a′, the wall-surface lower part 42b′, and the wall-surface left part and the wall-surface right part not shown) or the surface of the glass portion 34, the light becomes what is called stray light and is prevented from entering the light receiving units 33.

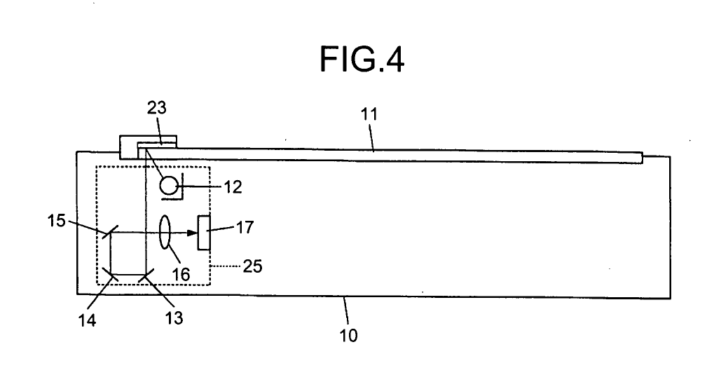

FIG. 4 is a modification of the image reading apparatus. Like reference numerals refer to like portions as those of the image reading apparatus shown in FIG. 1. This image reading apparatus is different from that shown in FIG. 1 in that the first mirror 13, the second mirror 14, the third mirror 15, the lens 16, and the image sensor device 17 are all located in a movable reading module 25. Based on the move of the reading module 25, the image on the document can be read.

While, in the first embodiment, the CCD 30 is explained as having the three light receiving units 33, the number of the light receiving units 33 is cited by way of example and without limitation. For example, one light receiving unit 33 for monochromatic light can be used.

While the light transmitting unit 42 is configured as an opening (hole) in the first embodiment, any configuration can be used when the light transmitting unit 42 can pass light to the light receiving units 33. For example, the light transmitting unit 42 can be configured by a transparent member that transmits light, or can be configured by two thin transparent members to seal air in between the transparent members.

As explained above, according to the first embodiment, the image reading apparatus includes the light transmitting unit on the substrate, and the substrate and the image sensor element mounted so that light from the light transmitting unit is incident to the light receiving unit on the surface of the image sensor element. Therefore, the entire back surface of the image sensor element can be exposed, and the heat dissipation area of the image sensor element can be increased. Consequently, heat dissipation efficiency of the image sensor element can be improved.

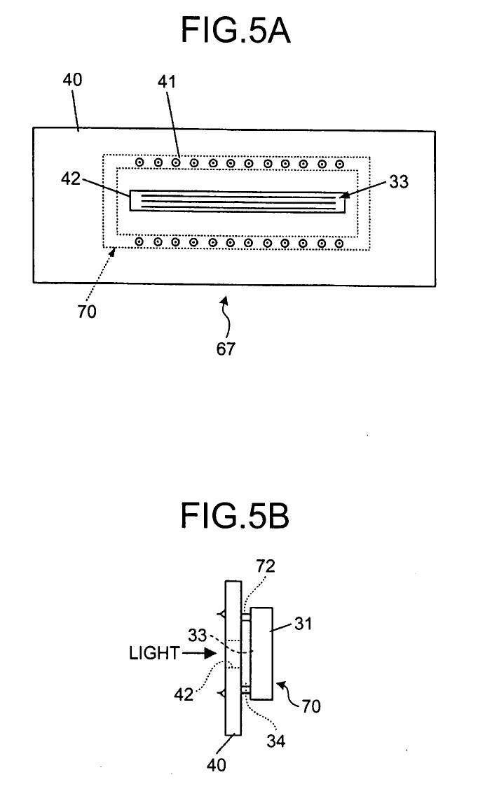

FIG. 5A is a top plan view of an image sensor device 67 according to a second embodiment of the present invention. FIG. 5B is a side view of the image sensor device 67. The image sensor device 67 includes a CCD 70 as an image sensor element, and the substrate 40 on which the CCD 70 is mounted. An image reading apparatus according to the second embodiment is in many respects basically similar to that of the first embodiment except for the image sensor device 67, i.e., the shape of lead terminals 72 of the CCD 70. Like reference numerals are utilized in designating corresponding portions of the image reading apparatus, and the same description is not repeated.

The image reading apparatus according to the second embodiment is also used for, as with that of the first embodiment, a scanner of an image forming apparatus such as a digital copier, or a single scanner apparatus.

The CCD 70 includes the package body 31, the lead terminals 72, the light receiving unit 33, and the glass portion 34. A plurality of the lead terminals 72 extends straight from both ends of the surface of the CCD 70, on which the glass portion 34 of the package body 31 is arranged, in the width direction of the CCD (direction perpendicular to the line direction). The lead terminals 72 are electrically and mechanically connected to the substrate 40. The substrate 40 includes the I/O terminals 41, the light transmitting unit 42, and a circuit (not shown).

The CCD 70 and the substrate 40 are electrically and mechanically connected to each other by piercing the lead terminals 72 of the CCD 70 through the I/O terminals 41 of the substrate 40, and soldering the CCD 70 and the substrate 40 together, like in the first embodiment. While the lead terminals 32 in the first embodiment are stretched from the side surfaces of the package body 31 in the width direction of the package body and are bent to the light receiving unit 33, the lead terminals 72 are stretched straight from the surface of the package body 31 on which the glass portion 34 is disposed. Therefore, the length of the lead terminals 72 after the CCD 70 is mounted on the substrate 40 is shorter than the length of the lead terminals 32 in the first embodiment.

When the length of the lead terminals 72 is short, the lead terminals 72 can avoid receiving noise from other circuit or can avoid giving noise to other circuit. Because there is no lead terminal 72 on the side surface of the package body 31 in the width direction of the package body (direction perpendicular to the line direction), a heat dissipation area increases, and heat dissipation efficiency of the CCD 70 can be improved.

As explained above, in the image reading apparatus according to the second embodiment, the lead terminals of the image sensor element extend straight toward the substrate. Therefore, the length of the lead terminals after the image sensor element is mounted on the substrate can be shortened. Consequently, the lead terminals 72 can avoid receiving noise from other circuit or can avoid giving noise to other circuit.

Further, according to the image reading apparatus of the second embodiment, there is no lead terminal on the side surface of the image sensor element, and a heat dissipation area of the image sensor element can be increased. Accordingly, heat dissipation efficiency of the CCD 70 can be further improved.

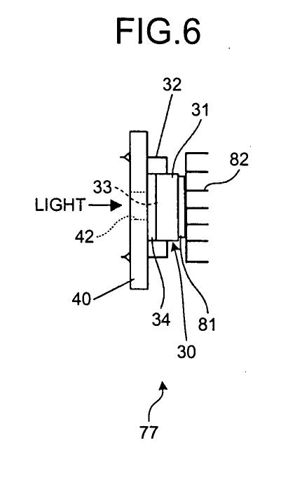

FIG. 6 is a side view of an image sensor device 77 according to a third embodiment of the present invention. An image reading apparatus according to the third embodiment is in many respects basically similar to that of the first embodiment except for the image sensor device 77, i.e., a heat dissipation member fitted to the back surface of the CCD 30 of the image sensor device 77. Like reference numerals are utilized in designating corresponding portions of the image reading apparatus, and the same description is not repeated.

The image reading apparatus according to the third embodiment is also used for, as with that of the first embodiment, a scanner of an image forming apparatus such as a digital copier, or a single scanner apparatus.

The image sensor device 77 includes the CCD 30, the substrate 40, an adhesive member 81, and a heat dissipation member 82. The CCD 30 includes the package body 31, the lead terminals 32, the light receiving unit 33, and the glass portion 34. The substrate 40 includes the I/O terminals 41, the light transmitting unit 42, and a circuit (not shown).

The adhesive member 81 is used to connect between the surface of the CCD 30 on which the package body 31 is exposed (the surface opposite to the light incident surface) and the heat dissipation member 82, and transfers heat from the CCD 30 to the heat dissipation member. It is ideal that the adhesive member 81 has high thermal conductivity.

The heat dissipation member 82 dissipates heat transferred from the CCD 30 via the adhesive member 81 to the atmosphere. The heat dissipation member 82 can have either a plane shape or a three-dimensional shape. When the heat dissipation member 82 has a shape having a large surface area, heat dissipation can be increased. A metal having high thermal conductivity is suitable for the material of the heat dissipation member 82.

In FIG. 6, sufficient space to fit the heat dissipation member 82 can be secured on the surface of the CCD 30 on which the package body 31 is exposed. Therefore, the heat dissipation member 82 having a three-dimensional shape can also be fitted as well as the heat dissipation member having a plane shape. It is difficult to fit the heat dissipation member to the whole back surface of the CCD 30 of the conventional image sensor device.

Therefore, the image sensor device 77 according to the third embodiment has the heat dissipation member 82 having heat dissipation effect superior to that of the image sensor device 17 according to the first embodiment.

Instead of using the adhesive member 81, the heat dissipation member 82 can be fixed to the CCD 30 or the substrate 40 by another method. In such a case, a similar effect can be achieved.

While, in the third embodiment, the image sensor device 77 has the heat dissipation member fitted to the CCD 30 explained in the first embodiment, the heat dissipation member can also be fitted to the CCD 70 explained in the second embodiment.

As explained above, in the image reading apparatus according to the third embodiment, the heat dissipation member is fitted to the back surface of the image sensor element. Thus, it is possible to further improve heat dissipation efficiency of the image sensor element.

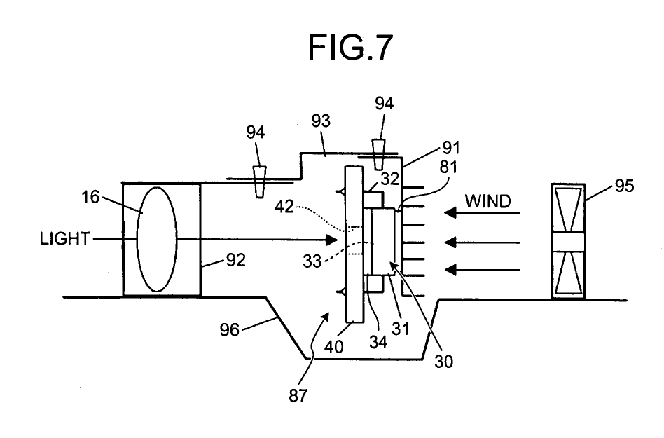

FIG. 7 is a schematic diagram of an image sensor device 87 according to a fourth embodiment of the present invention. An image reading apparatus according to the fourth embodiment is in many respects basically similar to that of the third embodiment except for the image sensor device 87, a fixing unit, and a fan device, i.e., a cooling device to cool a heat dissipation member. Like reference numerals are utilized in designating corresponding portions of the image reading apparatus, and the same description is not repeated.

The image reading apparatus according to the fourth embodiment is also used for, as with that of the first embodiment, a scanner of an image forming apparatus such as a digital copier, or a single scanner apparatus.

The image sensor device 87 includes the CCD 30, the substrate 40, the adhesive member 81, and a heat dissipation plate/CCD fixing member 91. The heat dissipation plate/CCD fixing member 91 has both the role of dissipating heat transferred from the CCD 30 via the adhesive member 81 to the atmosphere and the role of fixing the image sensor device 87. The CCD 30 includes the package body 31, the lead terminals 32, the light receiving units 33, and the glass portion 34. The substrate 40 includes the I/O terminals 41, the light transmitting unit 42, and a circuit (not shown).

Positional precision of the lens 16 and the CCD 30 is a characteristic that gives large influence to the image reading characteristic, and is required to have precision and stability. Therefore, instead of connecting between a lens fixing member 92 of fixing the lens 16 and the substrate 40, connecting the CCD 30 to the lens fixing member 92 is more advantageous to minimize the influence of warp which occurs on the substrate 40 due to a change in the ambient temperature.

However, because the CCD 30 has no fitting part, a fixing member is necessary to connect between the CCD 30 and the lens fixing member 92. Accordingly, the heat dissipation member is used for this fixing member. In other words, the heat dissipation plate/CCD fixing member 91 and the lens fixing member 92 are fixed together with a screw fixing member 94 via a fitting member 93. However, the heat dissipation plate/CCD fixing member 91 and the lens fixing member 92 can be connected to each other with a proper degree of freedom to be able to fix between the heat dissipation plate/CCD fixing member 91 and the lens fixing member 92 keeping positional precision after adjusting a position between the CCD 30 and the lens 16. In this case, the fitting hole of the fitting member 93 has preferably a long hole shape in the adjustment direction.

A fan device 95 is a cooling device that forcibly cools the heat dissipation plate/CCD fixing member 91, and is fixed to a frame 96 together with the lens fixing member 92.

The heat dissipation plate/CCD fixing member 91, the lens fixing member 92, the fitting member 93, the fixing member 94, and the frame 96 constitute the fixing unit.

In the image reading apparatus according to the fourth embodiment, the CCD 30 is disposed at the opposite side of the substrate 40 on which the lens 16 is disposed. According to the conventional image reading apparatus, the fan device 95 needs to be disposed at a position not affecting the optical system including the lens, to blow wind to the CCD 30. In this case, the fan device 95 is generally disposed at a position in a direction oblique to the optical path. However, when wind is blown, it is blown to the glass portion 34 of the CCD 30, and this has a problem of adhesion of dust or the like.

On the other hand, in the image reading apparatus according to the fourth embodiment, the fan device 95 can be disposed without particularly considering optical constraints to cool the CCD 30. Further, wind can be applied to the heat dissipation plate/CCD fixing member 91, without blowing wind to the glass portion 34 of the CCD 30. Therefore, adhesion of dust to the glass portion 34 of the CCD 30 can be prevented, and the wind volume of the fan device 95 can be increased. Thus, it is possible to improve cooling efficiency based on the fan device 95. Consequently, the image sensor device 87 according to the fourth embodiment has heat dissipation effect superior to that obtained from the image sensor device 77 according to the third embodiment.

As explained above, according to the image reading apparatus of the fourth embodiment, because the wind from the cooling device can be strongly blown to the heat dissipation member fitted to the back surface of the image sensor element, heat dissipation efficiency of the image sensor element can be further improved.

While the cooling method using air has been explained in the first to the fourth embodiments, a cooling method using water can also be used. In other words, a water cooler (cooling member) can be fitted to the back surface of the CCD. Other member (forced endothermic member) having an endothermic effect can also be fitted to the back surface of the CCD.

While the CCD is connected to the substrate by soldering after the lead terminals of the CCD are pierced through the I/O terminals of the substrate in the first to the fourth embodiments, the CCD can be connected to the substrate by other methods. For example, when the CCD is mounted on the surface and when a contact part is exposed instead of the lead terminals, the contact part can be mounted by reflow after mounting the contact part on the pad formed on the substrate, thereby connecting between the CCD and the substrate.

As set forth hereinabove, according to an embodiment of the present invention, a light transmitting unit is provided on a substrate, and the substrate and an image sensor element are faced to each other so that light is incident to a light receiving unit on a surface of the image sensor element through the light transmitting unit. Accordingly, the entire back surface of the image sensor element is opened. As a result, a heat dissipation area of the image sensor element can be increased, and heat dissipation efficiency of the image sensor element can be improved.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image sensor device that converts reflected light from an image surface into an electric signal, the image sensor device comprising:
a substrate;
a light transmitting unit that is located on the substrate, and transmits the reflected light; and
a light receiving unit that receives the reflected light, wherein
the light transmitting unit and the light receiving unit are arranged so that the reflected light passes through the light transmitting unit and is incident to the light receiving unit.

2. The image sensor device according to claim 1, wherein the light transmitting unit is formed in a size to expose at least a light receiving surface of the light receiving unit.

3. The image sensor device according to claim 1, wherein an inner circumference surface of the light transmitting unit in a thickness direction of the substrate is tapered in a direction in which the reflected light travels.

4. The image sensor device according to claim 1, wherein the light transmitting unit is a hole that constitutes a hollow part of the substrate.

5. The image sensor device according to claim 1, wherein the light transmitting unit is made of a material that transmits light.

6. The image sensor device according to claim 1, further comprising a heat dissipation member that is located near a surface of the light receiving unit other than a surface that receives the reflected light, and that dissipates heat from the light receiving unit.

7. The image sensor device according to claim 1, further comprising a cooling member that is located near a surface of the light receiving unit other than a surface that receives the reflected light, and that cools the light receiving unit.

8. The image sensor device according to claim 1, wherein the light receiving unit is located to face the substrate.

9. An image reading apparatus comprising:
an image sensor device that converts reflected light from an image surface into an electric signal, and that includes
a substrate;
a light transmitting unit that is located on the substrate, and transmits the reflected light; and
a light receiving unit that receives the reflected light, wherein
the light transmitting unit and the light receiving unit are arranged so that the reflected light passes through the light transmitting unit and is incident to the light receiving unit.

10. The image reading apparatus according to claim 9, further comprising a heat dissipation member that is located near a surface of the light receiving unit other than a surface that receives the reflected light, and that dissipates heat from the light receiving unit.

11. The image reading apparatus according to claim 10, further comprising a cooling device that cools the heat dissipation member.

12. An image forming apparatus comprising an image reading apparatus including an image sensor device that converts reflected light from an image surface into an electric signal, wherein
the image sensor device includes
a substrate;
a light transmitting unit that is located on the substrate, and transmits the reflected light; and
a light receiving unit that receives the reflected light, and
the light transmitting unit and the light receiving unit are arranged so that the reflected light passes through the light transmitting unit and is incident to the light receiving unit.
